(19) United States
(12) Patent Application Publication
(10) Pub. No.: US 2005/0151660 A1
(43) Pub. Date: Jul. 14, 2005

(54) System, method, and apparatus for remotely monitoring the status of a machine

(76) Inventor: David Wei Hua Mou, Moorpark, CA (US)

Correspondence Address: BACON & THOMAS, PLLC, 625 SLATERS LANE, FOURTH FLOOR, ALEXANDRIA, VA, 22314, US

(21) Appl. No.: 10/751,420

(22) Filed: Jan. 6, 2004

(51) Int. Cl. G08B 21/00

(52) U.S. Cl. 340/679; 340/531

(57) ABSTRACT

A system, method, and apparatus of remotely monitoring a status of a machine monitors machine status based on light emitted by a machine status indicator light on the machine. The light is detected by a photosensor and converted into signals for transmission to a remote receiver, network server, or other monitoring device.

### BACKGROUND OF THE INVENTION

1. Field of the Invention

This invention relates to a system, method, and apparatus for remotely monitoring the status of a machine, instrument, or device (hereinafter referred to collectively as a “machine”), and in particular to a system, method, and apparatus which remotely monitors the status of the machine by detecting indicator lights on the machine. The system, method, and apparatus of the invention can be used to monitor the status of any machine or other device having a status indicator light, without having to modify the machine, using a simple and inexpensive photosensor unit having wired or wireless remote communication capabilities.

2. Description of Related Art

Virtually all machines need to be monitored for proper operation. To facilitate monitoring, most machines are equipped with indicator lights that indicate the status of various machine functions, or that indicate malfunctions or conditions requiring attention or service. To monitor the machines, a human operator periodically checks the status indicators.

In many situations, it is desirable to monitor the machines remotely. For example, the machines to be monitored may not require the presence of a human operator during normal operation, or the machines may be too numerous or widely spaced to permit easy on-site monitoring. As a result, a variety of systems have been proposed to permit multiple machines to be monitored from a central location.

A typical example of such a remote monitoring system is described in U.S. Pat. No. 6,654,673. In this system, control modules which monitor machine functions supply information to a machine processor, which communicates through a “machine communication system” with a remote system.

The remote monitoring system described in U.S. Pat. No. 6,654,673 is designed to be used with tractors, pavers, and the like. Other remote monitoring systems that utilize built-in or retrofitted sensors include systems for monitoring vending machines (U.S. Pat. Nos. 6,628,764 and 5,997,170), office equipment such as printers and copiers (U.S. Pat. No. 6,631,247), air compressors (U.S. Pat. No. 6,529,590), appliances (U.S. Pat. Nos. 5,987,105, 5,757,643, 5,586,174, and 5,581,469), fuel oil tanks (U.S. Pat. No. 4,845,486), security/alarm systems (U.S. Pat. Nos. 6,587,046 and 6,553,336), and scientific instruments (U.S. Pat. No. 6,085,227), and machinery in general (U.S. Pat. Nos. 6,654,673 and 6,591,296). Also of interest are U.S. Pat. No. 6,078,874, which shows a system for manual collection of data from multiple machines, and U.S. Pat. No. 6,463,343 which discloses a system for monitoring and controlling a remote device uses video images of the device.

What all of the previously-proposed remote monitoring systems have in common is that each modifies the machine to be monitored by including a built-in communications module or interface connected with a sensor. The sensor may either already be included in the machine, as in U.S. Pat. No. 6,654,673, or may be added to the machine, as in U.S. Pat. No. 6,628,764, while the communications module can basically take any form, from wireless communications to telephone lines, to the DTMF generator of U.S. Pat. No. 6,987,105.

The communications modules or remote interfaces are in addition to any indicator lights used to indicate the status of machine functions. Although the indicator lights generally perform the same function as the remote communications systems, and are connected to the same sensors, separate signal processing capabilities must be included in order to convert the sensor outputs into a format suitable for remote communications. As compared with non-remotely monitored machines, the remotely monitored machines must generally be modified by the addition of processors for converting the sensor outputs into signals that can be remotely communicated, as opposed to signals that simply activate an indicator light. Of course different types of machines or equipment require different types of sensor, necessitating different types of processors and communications equipment.

The present invention, in contrast, enables remote monitoring without the need to adapt the remote communications equipment to different types of sensors, or to ensure compatibility between the sensor(s) and the communications equipment. It can be used with any type of machine that includes a status indicator light. None of the prior systems, methods, or devices for remotely monitoring a machine, as defined above, has this capability.

### SUMMARY OF THE INVENTION

It is accordingly a first objective of the invention to overcome the disadvantages of the prior art by providing a system, method, and device capable of monitoring a variety of machines, including existing machines with no remote communications capabilities.

It is a second objective of the invention to provide a system, method, and apparatus for remotely monitoring existing machines with no built-in communications capabilities, and without having to modify the machines to include such capabilities.

It is a third objective of the invention to provide a system, method, and apparatus for remotely monitoring a machine that can easily be set up by ordinary users without specialized knowledge or training.

It is a fourth objective of the invention to provide a remote machine monitoring system, method, and apparatus that is inexpensive and reliable.

It is a fifth objective of the invention to provide a apparatus for remotely monitoring multiple machine functions and/or parameters by using a single type of sensor.

These objectives are accomplished, in accordance with the principles of a preferred embodiment of the invention, by a monitoring apparatus that includes a photosensor for detecting the light output of an indicator light on the machine, and an interface for transmitting signals representative of the results of the detection to a remote receiver. According to one preferred embodiment of the invention, the interface includes a wireless transmitter, although the it is also within the scope of the invention to use a wired connection.

The remote receiver may be equipped to receive signals from one or multiple machines. In addition, the transmitter or receiver may include circuitry or software for converting the signals into Internet Protocol (IP) packets and sending or forwarding machine status information via the Internet to a remote monitoring server.

Depending on the nature of the status indicator light provided on the machine, the photosensor may be responsive to color, light intensity, illumination patterns of multiple lights, flashing patterns or timing, or simply whether a particular status indicator light is on or off. Because the sensor unit output simply indicates the color, brightness, or the like of the indicator light, the hardware or software for transmitting and monitoring the signals can be extremely simple, and it is not necessary to use high rate transfer devices.

It will be appreciated by those skilled in the art that the principles of the invention may be applied to any type of machine, device, equipment, instrument, appliance and so forth, so long as the machine, device equipment, instrument, and the like includes an indicator light.

### BRIEF DESCRIPTION OF THE DRAWINGS

FIG. 1 is a schematic diagram of a machine monitoring system constructed in accordance with the principles of a preferred embodiment of the invention.

FIG. 2 is a schematic diagram showing details of the sensor unit of the invention, together with the indicator lights of a machine being monitored.

FIG. 3 is a flowchart of a machine monitor set-up method according to the principles of preferred embodiment of the invention.

FIG. 4 is a flowchart of a main monitoring program for implementing the monitoring method of the invention.

FIGS. 5-11 are flowcharts of various subroutines for use with the main monitoring program of FIG. 4.

FIG. 12 is a flowchart of a data collection/alarm program for implementing the monitoring system and method of the preferred embodiment.

FIGS. 13-16 show various set-up forms for use with the organization subroutine illustrated in FIG. 5.

FIGS. 17-19 show status display screens generated by the status subroutine of FIG. 6.

FIG. 20 shows a critical level display screen generated by the critical level subroutine of FIG. 7.

FIGS. 21-25 show forms and display screens related to the query subroutine of FIG. 8.

FIGS. 26 and 27 show data input forms for use with the respective schedule and labor subroutines of FIGS. 9 and 10.

FIG. 28 shows a display screen generated by the maintenance reminder subroutine of FIG. 11.

### DETAILED DESCRIPTION OF THE PREFERRED EMBODIMENTS

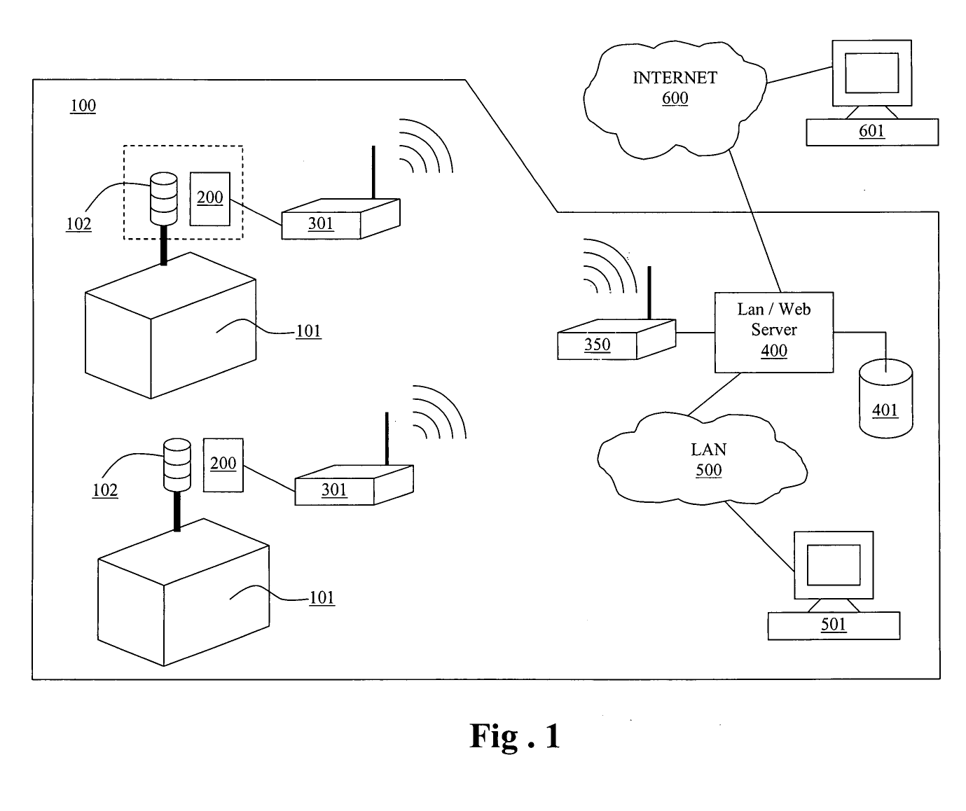

As illustrated in FIG. 1, a machine monitoring system constructed in accordance with the principles of a preferred embodiment of the invention includes at least one machine 101 to be monitored. Machine 101 may, by way of example and not limitation, be one of a plurality of machines on the floor of a machine shop, factory, office, or other facility 100, and must include at least one status indicator light 102. Machine 101 may be any type of machine, device, instrument, equipment, or the like having at least one status light.

The status indicator light is monitored by a photo sensing unit 200 connected to or including a wireless transmitter 301. Also situated in the machine shop, factor, office, or other facility 100 is a receiver 350 capable of receiving signals from, at least, one transmitter 301. Preferably, receiver 350 is capable of receiving signals from a plurality of transmitters 301 to enable monitoring of multiple machines.

Receiver 350 may be directly connected to a device for interpreting the received signals and/or displaying the results of the monitoring at a central location in the facility 100. In addition, receiver 350 may be connected to or include a database 401 for storing the received signals or data based on the signals, and/or may be directly connected to a local area network (LAN) and/or web server 400. Server 400 may in turn may be connected through a LAN 500 to a monitoring personal computer (PC), laptop, or mainframe 501, and/or through the Internet 600 to remote monitoring computers 601.

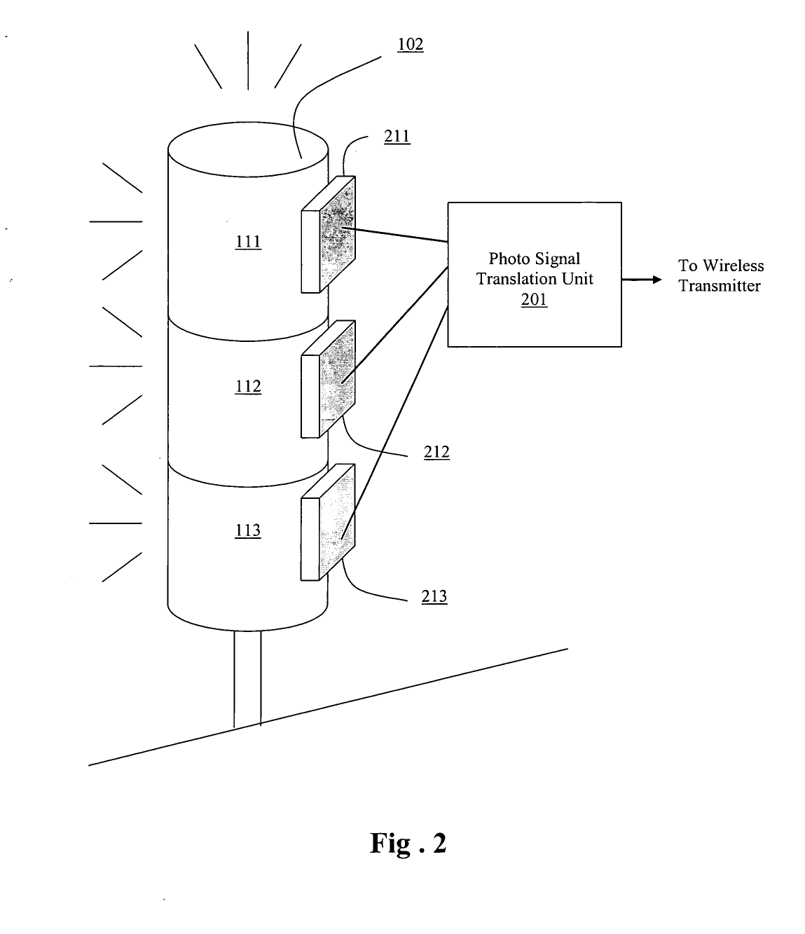

As shown in FIG. 2, the at least one indicator light 102 of FIG. 1 may include multiple indicator lights 111, 112, and 113. The illustrated number of indicator lights will be understood to be exemplary in nature and is not intended to be limiting. Depending on the type of machine, the number of lights could be any number, and each light or combination of lights may indicate a different function or parameter based on color, brightness, on/off status, flashing or illumination pattern, or any combination of the above.

The photosensing unit preferably includes a photosensor 211,212,213 for each light to be monitored, although there may be circumstances where a single sensor may be used to monitor multiple adjacent lights, or a single light might be monitored by multiple sensors. The photosensors monitor the output level, color, or on/off status, etc., of the lights in any combination, as appropriate. For example, one sensor could monitor the color of one light, and another sensor could monitor the on/off status of the same light or a different light or lights. Each photosensor unit contains some type of signal processing unit 201 for converting the signals output by the photosensors 211,212,213 into signals suitable for transmission. The signals are preferably sent by the photosensor unit to a wireless transmitter, although wired electrical or fiber optic communications may also be used. The invention is not to be limited to any particularly type of wireless or wired transmission device or method. Examples of photosensors include CDS sensors or phototransistors, although the invention is intended to encompass any other appropriate light sensing device. The outputs of the photosensors may be interpreted as single bits in the case of simple on/off monitoring, or the output may consist of a count or integration in the case of flashing or brightness.

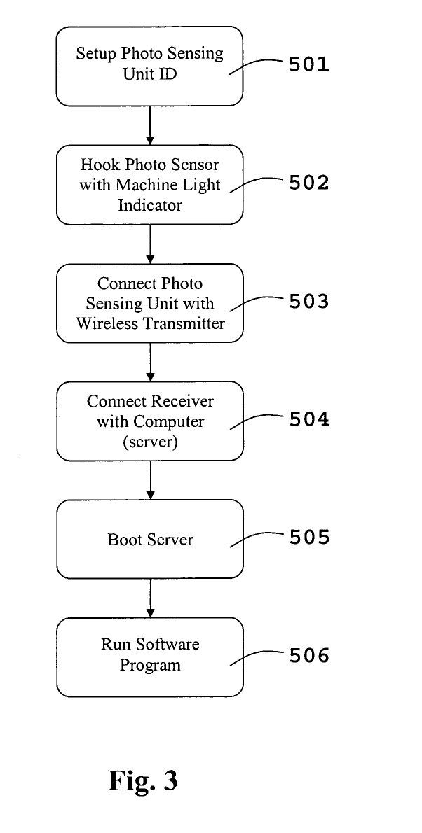

The set-up procedure for the system and apparatus illustrated in FIGS. 1 and 2 is shown in FIG. 3. Preferably, it can be carried out by persons without special training or knowledge of electronics, signal processing, or the like. As indicated by step 501 of the method of FIG. 3, if multiple photosensing units are used, the photosensing unit must be provided with an identifier (ID) so as to distinguish signals received from one photosensing unit from signals received from other photosensing units. This may involve setting DIP switches, or may be accomplished by means of software. In step 502, the photosensor must be positioned or mounted at a position on or adjacent the machine so as to sensor light output by a machine light indicator. The photosensing unit is then connected, in step 503, with a transmitter, although it is also possible to build the transmitter into the photosensing unit so that in situ connection is not necessary. The receiver then must be connected or plugged into a computer or server, as described above, and the server must be booted or otherwise started-up (step 504). Finally, software for operating the sensing unit and/or for monitoring received signals and forwarding the signals to a LAN or the Internet may be run (step 506).

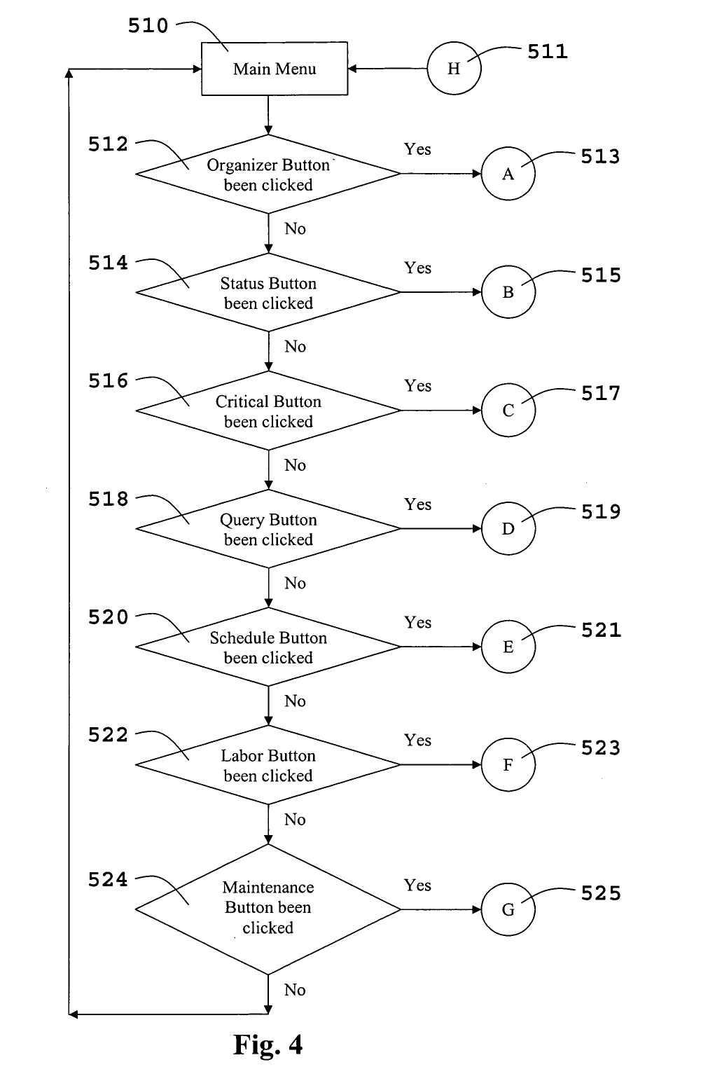

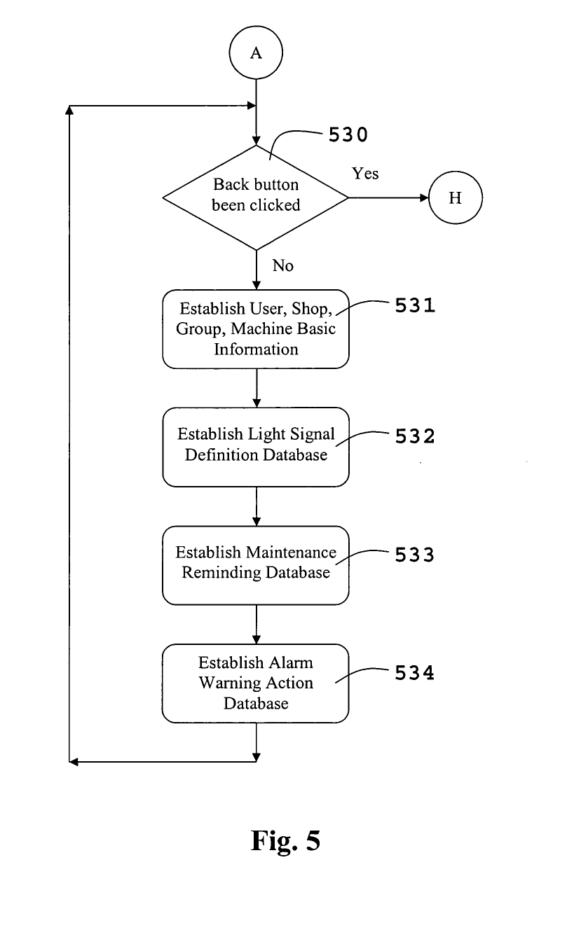

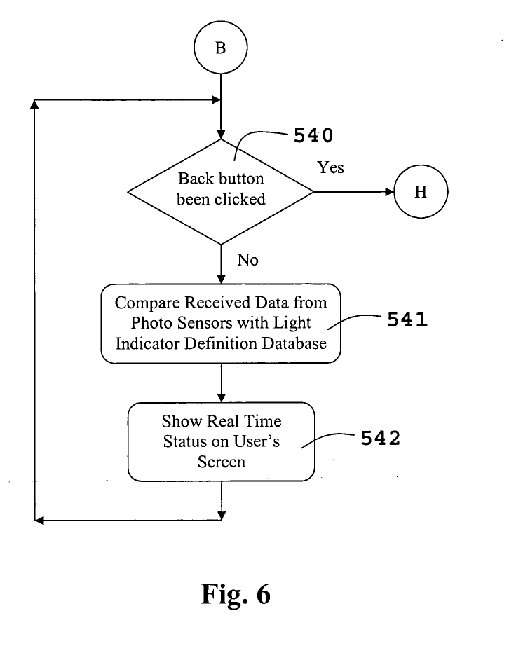

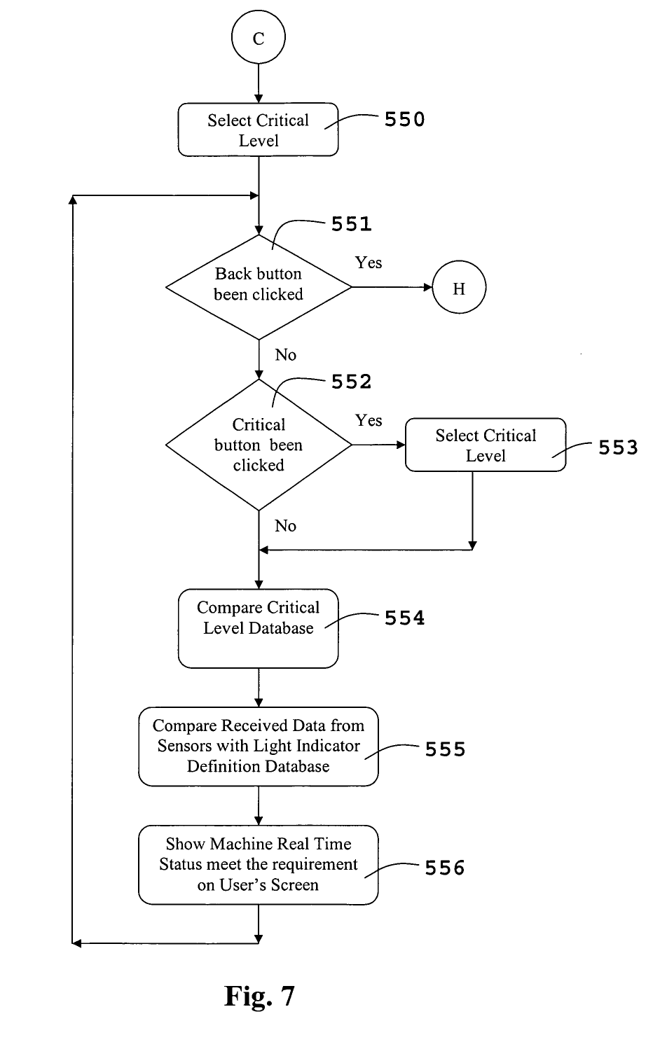

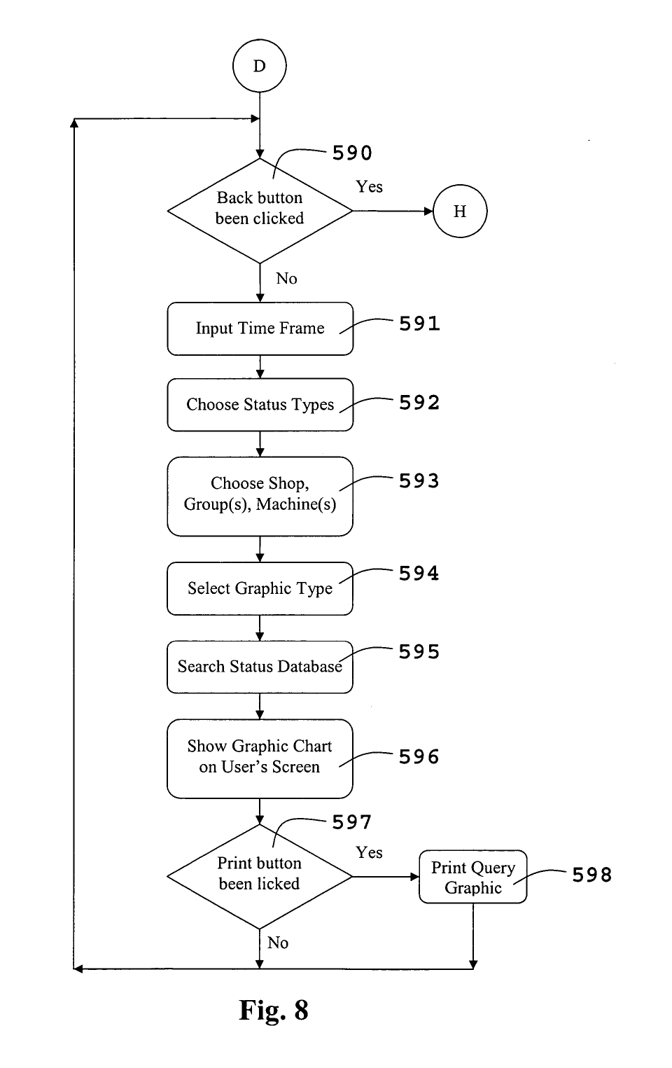

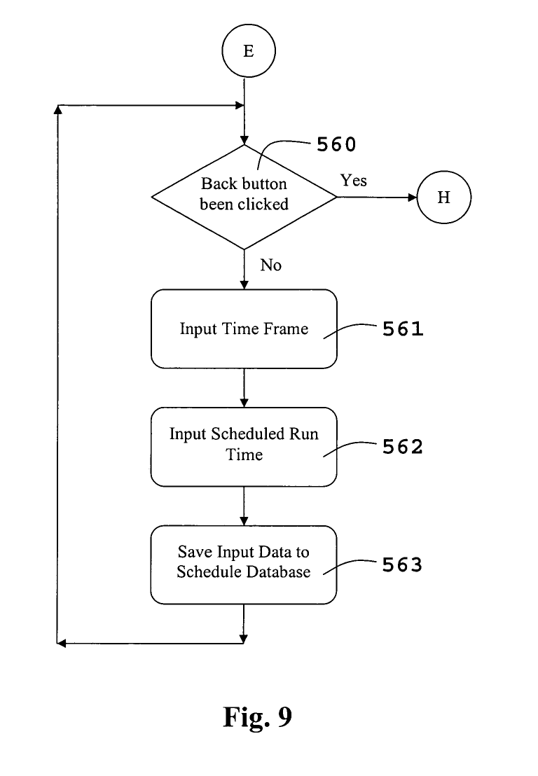

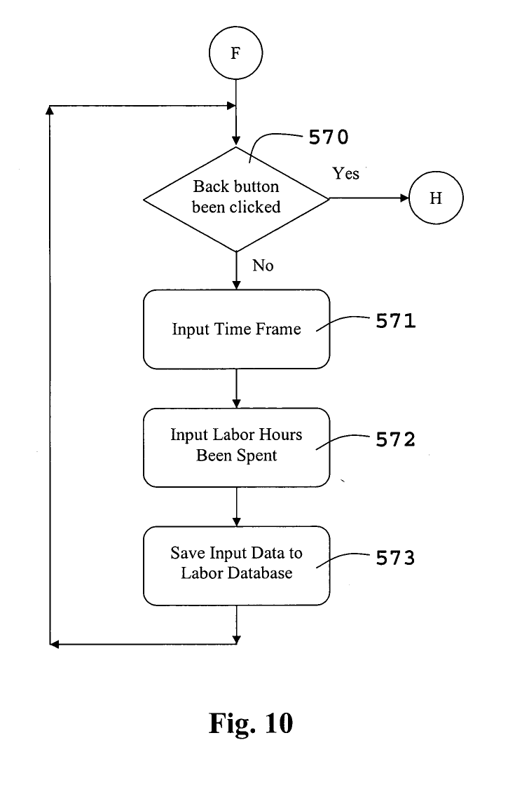

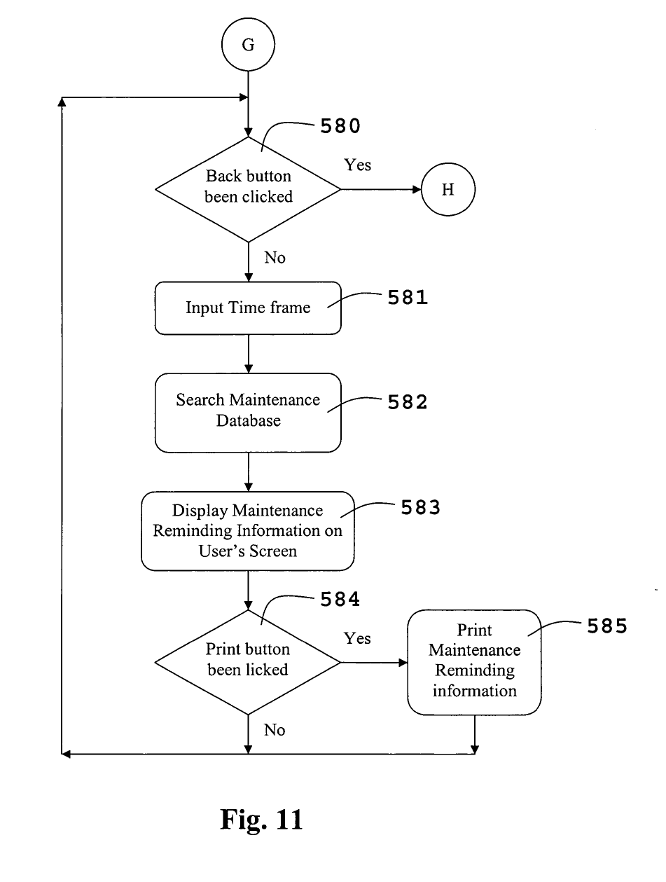

The main monitoring program illustrated in FIG. 4 begins in step 510 with display of a main menu, which is called upon start-up or upon selection of a back button (step 511) during execution any of the subroutines illustrated in FIGS. 5-11. If the main program determines that an organizer button has been selected from the main menu (step 512), the main program proceeds in step 513 to the organizer subroutine illustrated in FIG. 5. If the main program determines in step 514 that a status button has been selected, the main program proceeds in step 515 to the status subroutine illustrated in FIG. 6. If the main program determines in step 516 that a critical button has been selected, the main program proceeds in step 517 to the critical button subroutine illustrated in FIG. 7. If the main program determines in step 518 that a query button has been selected, the main program proceeds in step 519 to the query subroutine illustrated in FIG. 8. If the main program determines in step 520 that a schedule button has been selected, the main program proceeds in step 521 to the schedule subroutine illustrated in FIG. 9. If the main program determines in step 522 that a labor button has been selected, the main program proceeds in step 523 to the labor button subroutine illustrated in FIG. 10. If the main program determines in step 524 that a maintenance button has been selected, the main program proceeds in step 525 to the maintenance subroutine illustrated in FIG. 11.

FIG. 5 shows an “organizer” subroutine for inputting basic information and setting up various displays. If the organizer subroutine of FIG. 5 determines that the back button has been pressed (step 530), it returns to the main program. Otherwise, the subroutine enables input of user, shop, group, and machine basic information (step 531), establishes a light signal definition database to interpret signals received from the various sensor units that transmit to the receiver or receivers to which the computer running the monitoring program is connected (step 532), establishes a maintenance reminder data base for storing maintenance intervals (step 533), and establishes an alarm warning action data base for providing warnings in response to various sensed machine conditions (step 534).

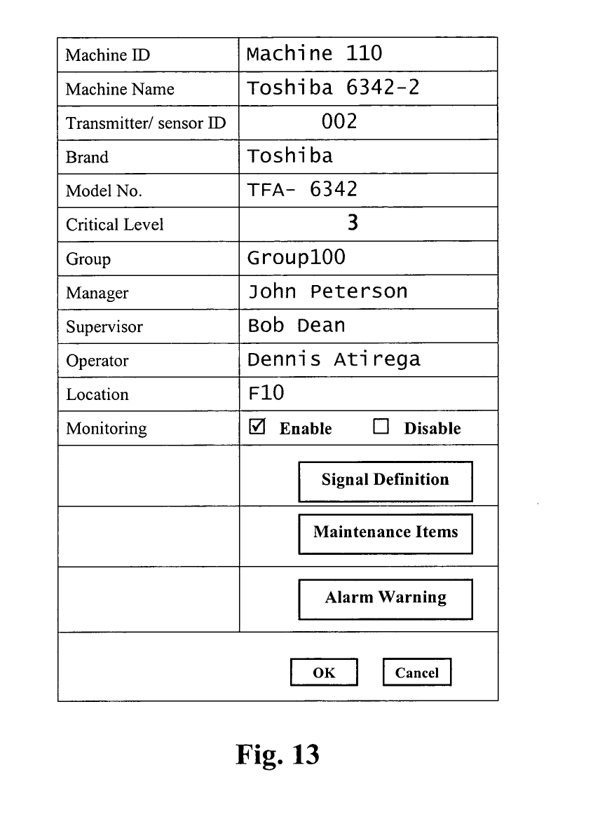

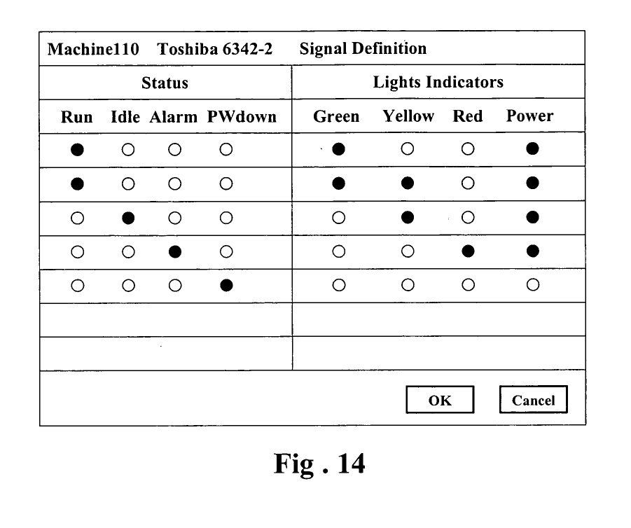

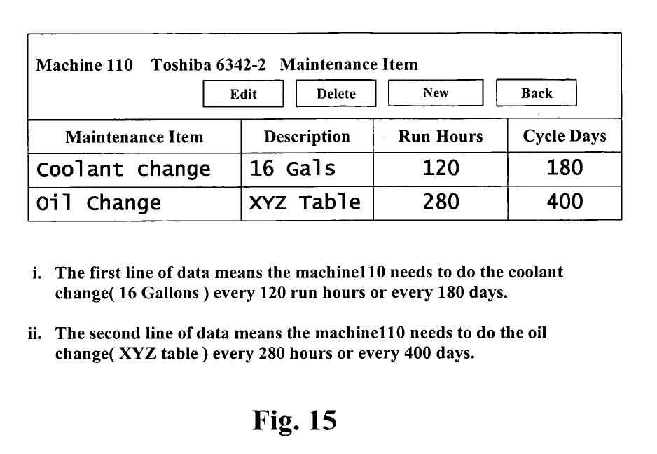

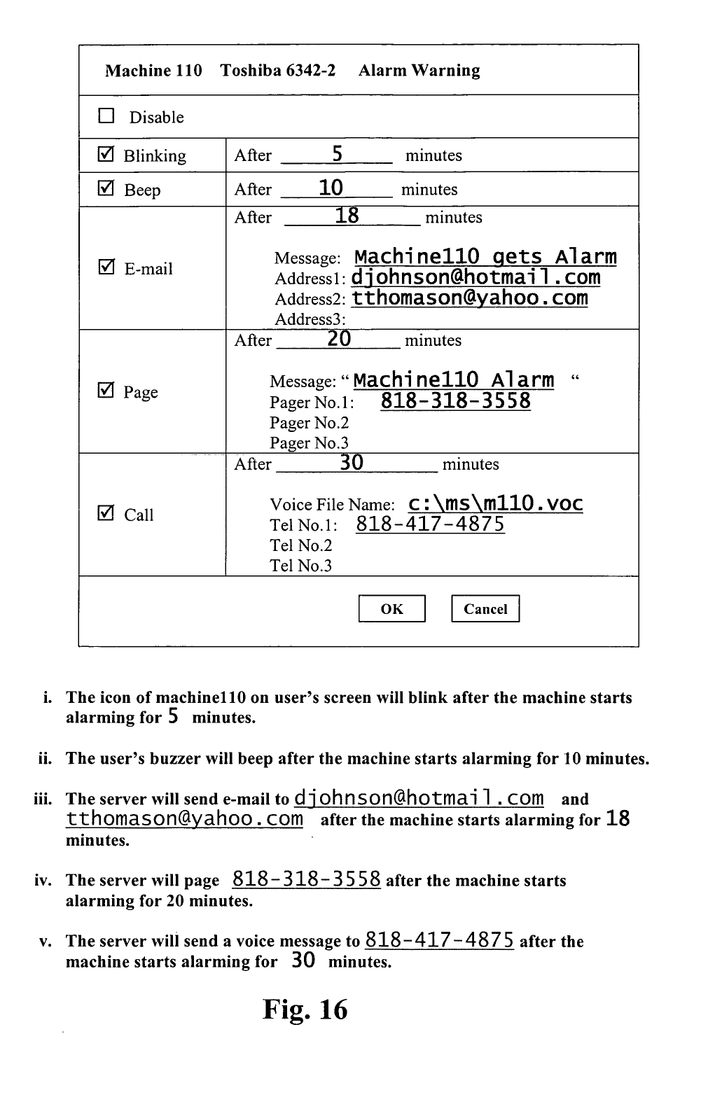

An example of a machine organizer set-up form for inputting the basic information to the subroutine of FIG. 5 is illustrated in FIG. 13. The form includes spaces for input of a machine I.D. and name, transmitter/sensor identification, brand, model number, critical level, various information on responsible personnel and machine location, and whether monitoring is to be carried out, as well as links to forms for signal definition, illustrated in FIG. 14, maintenance reminder scheduling (illustrated in FIG. 15) and alarm warning format (illustrated in FIG. 16). The signal definition form shown in FIG. 14 correlates status with, in this example, status indicator light colors and the on/off condition of a power indicator light. The maintenance scheduling form illustrated in FIG. 15 correlates maintenance reminders with monitored run time, and the alarm set-up form illustrated in FIG. 16 permits selection of an alarm format (by way of example and not limitation, a flashing light, audible warning, e-mail, page, and telephone call) for notifying a user that the indicator light on the monitored machine is indicating an alarm.

The status display subroutine of FIG. 6 permits display of monitoring results for the entire facility being monitored. If the status subroutine of FIG. 6 determines that the back button has been pressed (step 540), it returns to the main program. Otherwise, it compares, in step 541, data received from the photosensors with interpretive definitions stored in the indicator definition data base established in step 532 of FIG. 5, and displays the results in step 542.

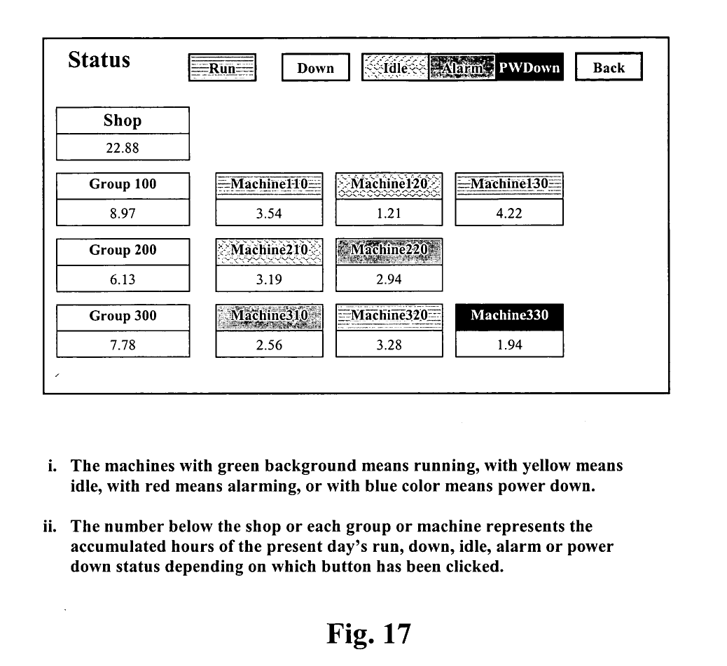

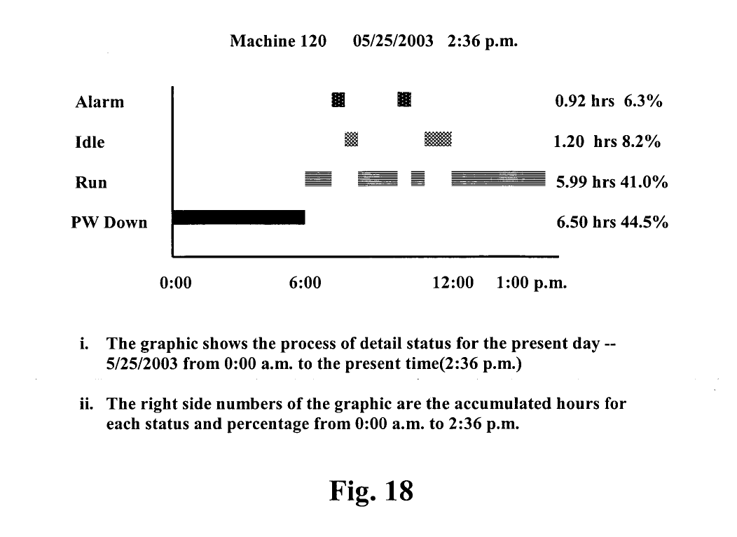

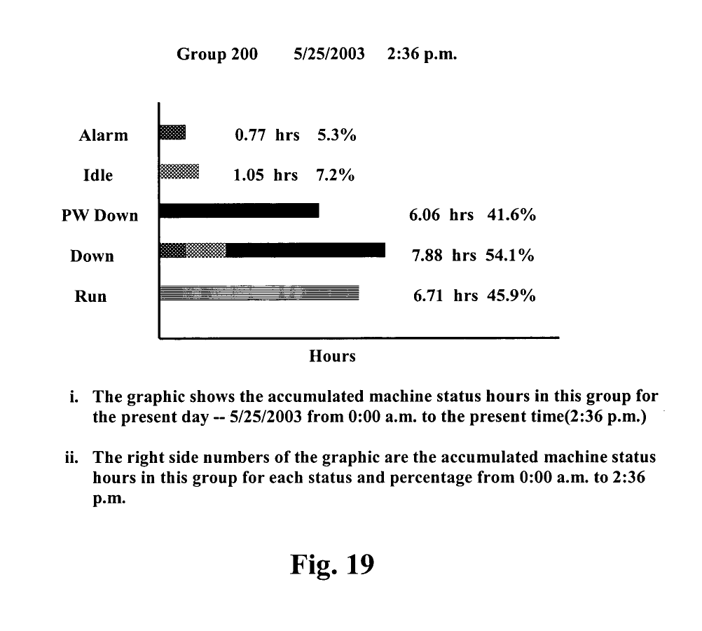

The status display thus generated may take the form illustrated in FIGS. 17-19, although it is of course not limited thereto. The overall status display illustrated in FIG. 17 includes shop and machine identifiers, including blocks labeled “Machine###” for each machine being monitored, colors in the machine blocks (not shown) corresponding to the colors of run status indicator lights on the machines, and numbers representing accumulated run, down, idle, alarm, or power down times depending on which corresponding button at the top of the status display has been selected. The detailed status displays in FIGS. 18 and 19 are summoned by selecting one of the machine blocks included in the display of FIG. 17, in order to display more detailed status data for an individual machine.

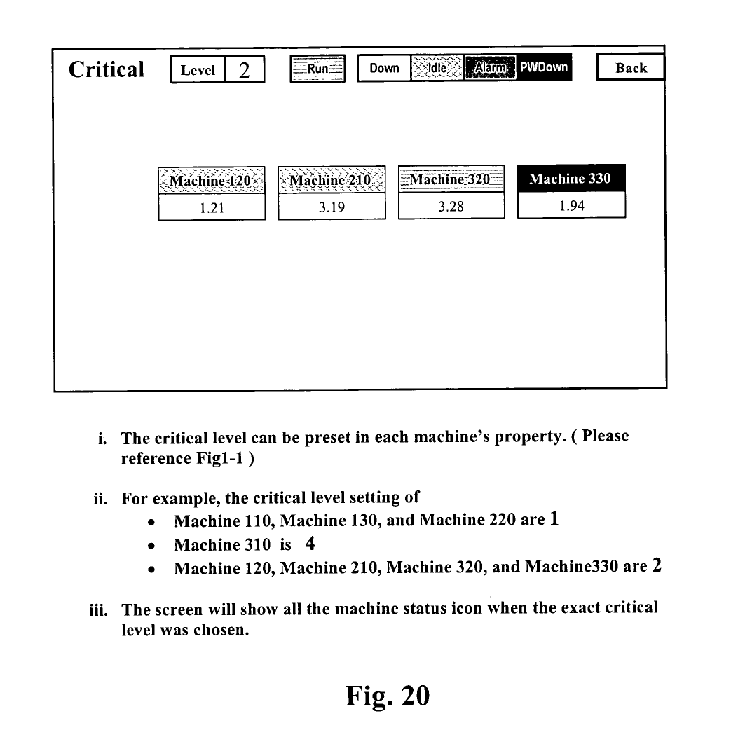

The critical subroutine displays the status of machines having a pre-determined level of criticality. In the critical subroutine of FIG. 7, the user is first prompted (step 550) to select or input a critical level. If the critical subroutine of FIG. 5 determines that the back button has been pressed (step 551), it returns to the main program. Otherwise, if the critical subroutine determines that the critical button has been selected (step 552), and a critical level has been input (step 553), the input critical level definitions are retrieved from the critical level data base (step 554) and the subroutine proceeds to compare data received from the sensors with light indicator definition of critical machines (step 555) and display status of those machines that meet the criteria for critical level (step 556). An example of a critical level display of the status of machines having critical level “2” is illustrated in FIG. 20.

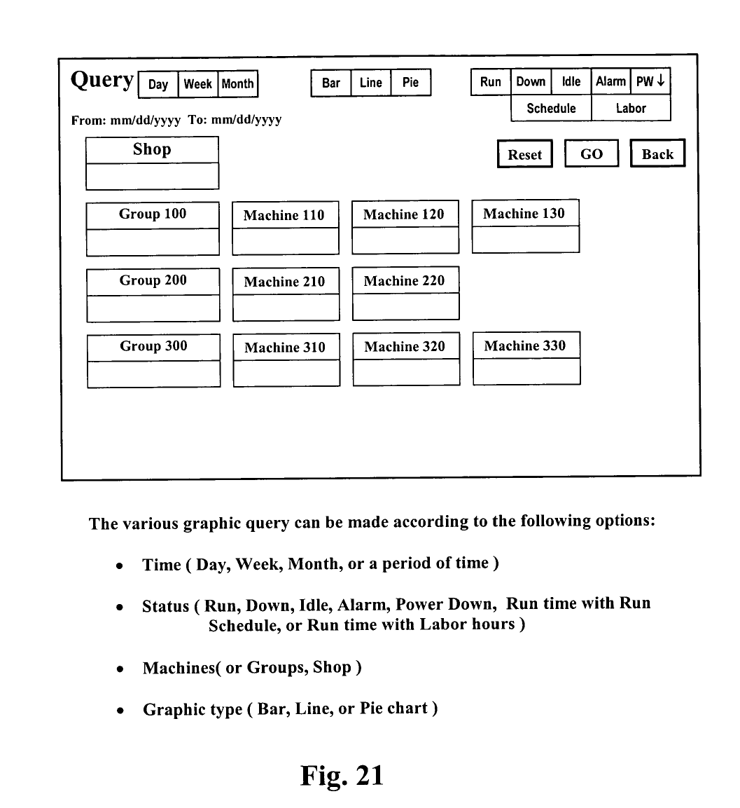

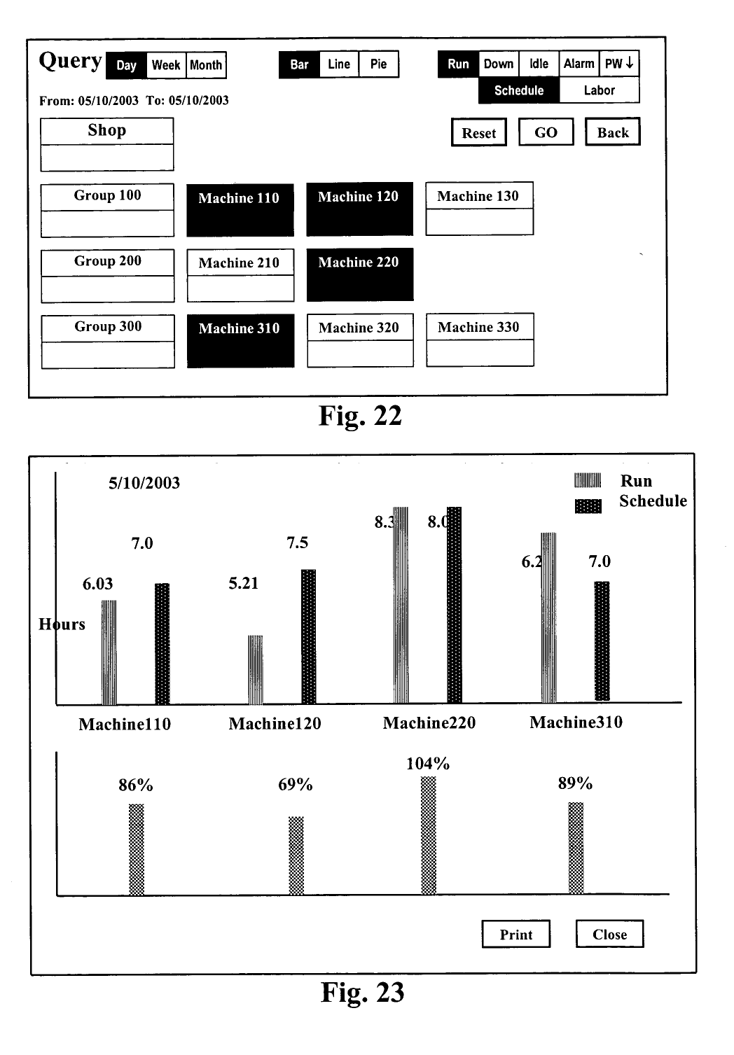

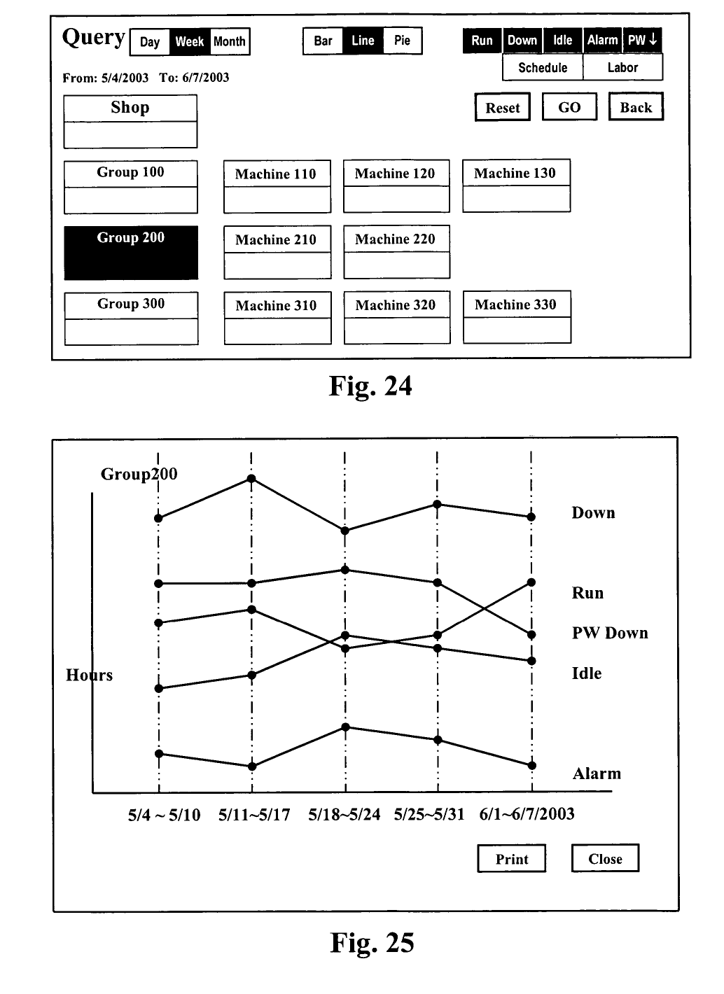

The query subroutine of FIG. 8 permits display of historical status information, by selected time frame, for many of the monitored machines. After verifying in step 590 that the back button has not been selected, the query subroutine requests input of a time frame for the status information to be displayed (step 591), the types of status information to be displayed, such as run, down, alarm power down times, or run times with schedule or labor hours (step 592), the shops, groups, or machines to be included in the display (step 593), and the format of the display, e.g., bar, line, or pie chart (step 594). In step 595, the query subroutine retrieves the historical status data from the status database and in step 596 displays the result. Finally, in steps 597 and 598, the subroutine permits the display to be printed. FIG. 21 shows a blank form for implementing data input steps 591-594, FIG. 22 shows a form with time frame entered, FIG. 23 shows an example of a run/schedule display in bar format generated in step 596 of FIG. 8 and selected from the form of FIG. 24, and FIG. 25 shows an example of an alternative status display in line format selected from the form of FIG. 24.

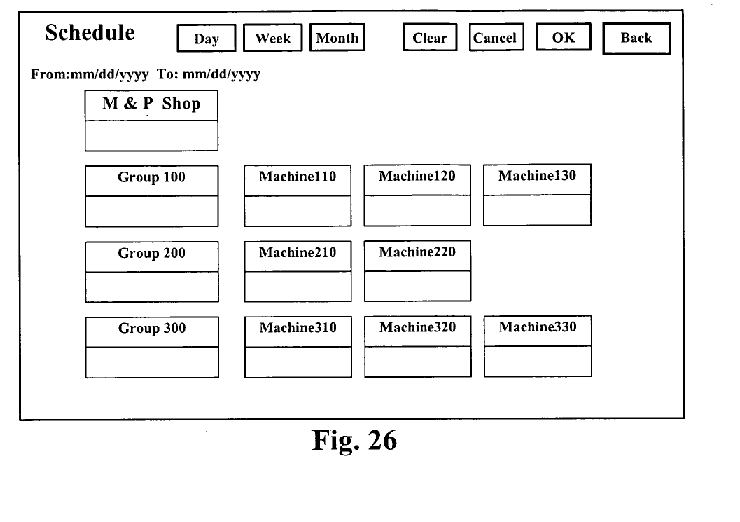

The schedule subroutine illustrated in FIG. 9 permits input of scheduled machine run time for comparison with actual run time. If the schedule subroutine of FIG. 9 determines that the back button has been pressed (step 560), it returns to the main program. Otherwise, it prompts the operator for input of a time frame during which comparison is to occur (step 561), and scheduled run time(s) for the monitored machines (step 562), and saves the time frame and run time inputs to the schedule database (step 563). As example of a form for implementing this subroutine is illustrated in FIG. 26.

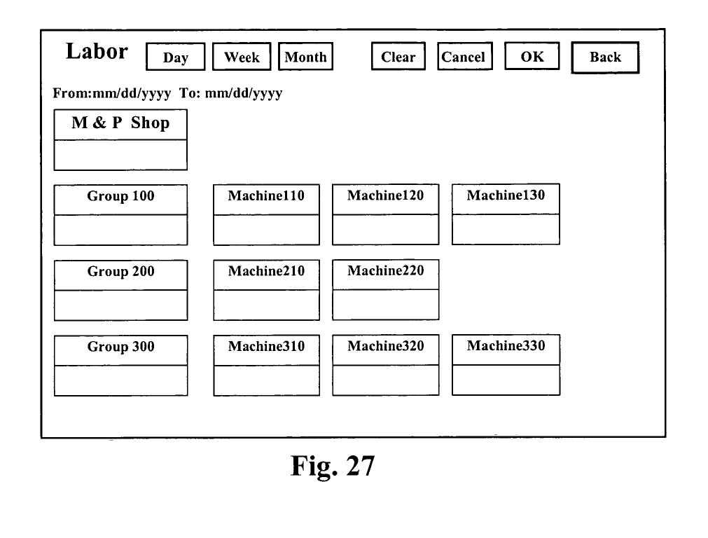

The labor subroutine permits monitoring of machine runtime for comparison with payroll. If the labor subroutine of FIG. 10 determines that the back button has been pressed (step 570), it returns to the main program. Otherwise, the labor subroutine prompts the user for a time frame input (step 571) and payroll or time sheet information (step 572), and save the result to a labor database (step 573). An example of a form for entry of the labor hours is illustrated in FIG. 27.

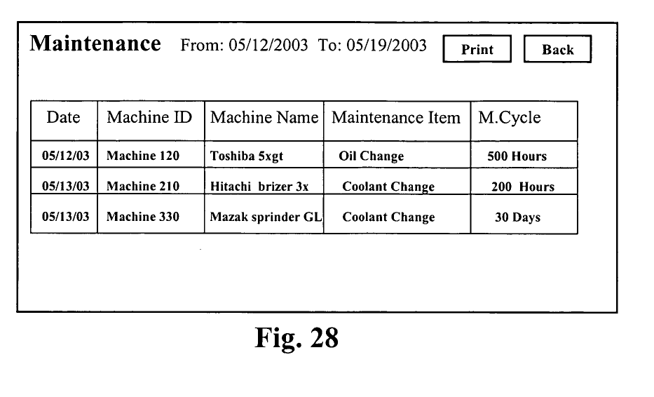

Finally, the maintenance reminder subroutine illustrated in FIG. 11 compares preset run time with a stored maintenance schedule to generate maintenance reminders. If the maintenance reminder subroutine of FIG. 11 determines that the back button has been pressed (step 530), it returns to the main program. Otherwise, the maintenance reminder subroutine prompts for entry of a time frame to be checked (step 581), searches the maintenance database (step 582), displays retrieved maintenance reminder information (step 583), determines whether a print button has been selected (step 584), and prints the information if the print button has been selected (step 585). An example of a maintenance reminder display generated in step 583 of FIG. 11 is shown in FIG. 28.

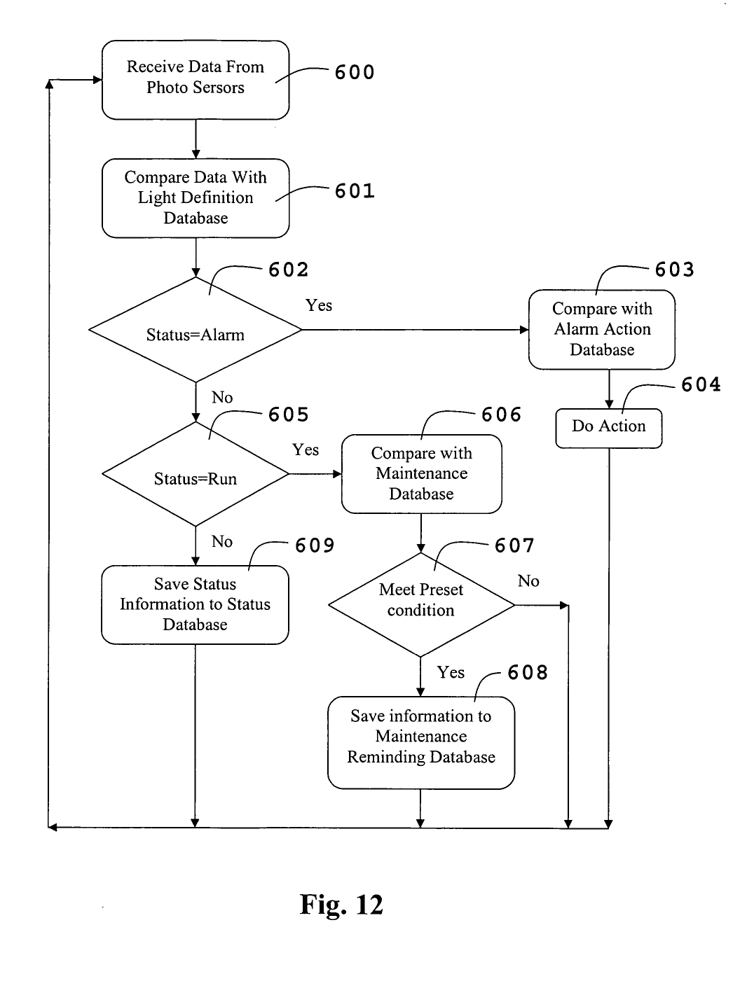

The data collecting program illustrated in FIG. 12 monitors status data transmitted by the sensor units for alarm and run conditions. In step 600, the program receives data by wired or wireless transmission to the receiver 350 of FIG. 1 and, optionally, via IP transmission over a LAN or the Internet, after which the data is compared in step 601 with definitions included in a corresponding database such as database 401.

The definitions retrieved in step 601 correlate a particular lighting condition with a particular machine status. For example, a red status indicator light might indicate an alarm condition, and a green status indicator light might indicate a run condition. It will be appreciated by those skilled in the art that the definitions will depend on the type of machine being monitored, and on the status assigned to the light condition by the manufacturer or operator of the machine being monitored, and that the program illustrated in FIG. 12 may need to be adapted to correspond to particular machines or types of machines.

In the example illustrated in FIG. 12, if an alarm status is indicated by the received data, as determined by step 602, the alarm action database is searched in step 603 and an appropriate action is taken in step 604 (as described above in connection with FIGS. 5 and 16). If a run status is indicated by the received data, as determined by step 605, the maintenance database is searched in step 606 and a determination is made in step 607 if a reminder is required. In either case the data is saved in steps 608 and 609 for use in generating historical data or query displays in connection with the query subroutines of FIGS. 8-10.

Having thus described a preferred embodiment of the invention in sufficient detail to enable those skilled in the art to make and use the invention, it will nevertheless be appreciated that numerous variations and modifications of the illustrated embodiment may be made without departing from the spirit of the invention, and it is intended that the invention not be limited by the above description or accompanying drawings, but that it be defined solely in accordance with the appended claims.

1. A system for remotely monitoring a machine having a status indicator light, comprising:
a sensor unit including at least one photosensor arranged to detect light emitted by the indicator light and a remote communications interface, said sensor unit being arranged to detect at least one of the following parameters: color, brightness, flashing pattern, and illumination pattern;
a receiver remotely situated relative to said sensor unit and arranged to receive signals generated by said sensor in response to detection of light emitted by said indicator light; and
a computing device arranged to interpret said signals in order to indicate a status of said machine.

2. A system as claimed in claim 1, wherein said remote communications interface includes a wireless transmitter, and said receiver is a wireless receiver.

3. A system as claimed in claim 1, wherein said receiver is arranged to receive signals from a plurality of said sensor units, each identifiable by a unique identifier.

4. A system as claimed in claim 3, wherein said receiver is connected to a network server.

5. A system as claimed in claim 4, wherein said server is connected to a local area network.

6. A system as claimed in claim 4, wherein said server is connected to the Internet.

7. A system as claimed in claim 1, wherein said sensor unit includes multiple photosensors for monitoring multiple machine status indicator lights.

8. (canceled)

9. A system as claimed in claim 1, wherein said photosensor is arranged to monitor an on/off condition of said indicator light.

10. (canceled)

11. (canceled)

12. (canceled)

13. (canceled)

14. (canceled)

15. A method of remotely monitoring a machine, comprising the steps of:
detecting a parameter of light emitted by a status indicator light on the machine, said parameter including at least one of the following: color, brightness, flashing pattern, and illumination pattern;
transmitting signals representative of the detected light to a remote location; and
providing, at the remote location, an indication of the status of the machine based on the transmitted signals.

16. A method as claimed in claim 15, wherein the step of transmitting signals comprises the step of wirelessly transmitting the signals.

17. A method as claimed in claim 15, wherein the step of transmitting signals further comprising the step of converting the signals into packets for transmission over the Internet.

18. A method as claimed in claim 15, wherein the step of detecting light comprises the step of detecting light from indicator lights on a plurality of machines, and wherein the step of transmitting signals comprises the step of transmitting signals from sensor units at the plurality of machines to a single centrally located receiver.

19. A method as claimed in claim 15, wherein the step of detecting light comprises the step of detecting light from multiple lights on a single machine.

20. (canceled)

21. A method as claimed in claim 15, wherein the step of detecting light comprises the step of detecting an on/off status of said indicator light.

22. Monitoring software for remotely monitoring a status of a machine comprising:
means for receiving data indicative of the status of at least one indicator light on at least one said machine;
means for retrieving definitions from a database and comparing the received data with the definitions; and
means for displaying a result of said comparison.

23. Monitoring software as claimed in claim 22, further comprising means for storing results of said comparison and later displaying said stored results as historical data.

24. Monitoring software as claimed in claim 22, further comprising means for calculating a run time based on said data and for comparing said run time with a maintenance schedule in order to generate maintenance reminders.

25. Monitoring software as claimed in claim 22, further comprising means for calculating a run time based on said data and comparing said run time with labor records.

26. Monitoring software as claimed in claim 22, further comprising means for providing a warning to a user upon detection of an alert status of said indicator light
